(19) United States
(12) Patent Application Publication
(10) Pub. No.: US 2004/0023633 A1
(43) Pub. Date: Feb. 5, 2004

(54) Handheld wireless device holder

(76) Inventor: Mark A. Gordon, Oxnard, CA (US)

Correspondence Address: G. Kivenson, 22030 Wyandotte St., Canoga Park, CA, 91303, US

(21) Appl. No.: 10/208,618

(22) Filed: Jul. 31, 2002

(51) Int. Cl. H04B 1/06

(52) U.S. Cl. 455/345; 455/346; 455/557

(57) ABSTRACT

A system for mounting a cell phone in an automobile providing vibration resistant holding, phone battery recharging, rapid disconnect and convenient mounting on an article of clothing such as a belt.

The widespread use of cell phones in automobiles was initially considered dangerous because it tied up one hand of the driver. Some individuals tried to trap the phone between their shoulder and ear and thus retain the use of both hands. This practice distorted their view when making turns however and did not solve the problem. As a result, there have been a large number of devices developed and sold for fixing the cell phone to the front of the instrument panel so that the driver's hands would be free. Many of these solutions to the problem have been satisfactory but the additions to the cell phone were elaborate and relatively costly. Some phones were not loud enough to be heard from a distance of several feet although the microphones were sensitive enough to pick up the driver's voice from that distance. Another difficulty lay in the necessity of coupling the phones electrical system with that of the car so that the limited power of the phone battery could be enhanced by that of the generator-storage cell system of the automobile. A possible solution would be for the phone to be charged when not in use by the motorist or passengers.

An entirely different series of problems occurring when the phone is fixed to the car consists of mechanical vibration when the car is in motion. The grip of the holding means on the body of the telephone must be sufficient to prevent the phone from working loose and falling to a lower position. The relatively thin plastic shells housing many cell phones would be an argument against a large clamping force.

Many cell phones lose their range when in the interior of automobiles, which represent metal shields surrounding them. Additional shielding occurs when the automobile enters a tunnel or indoor garage. It would also be convenient if the extra antenna would automatically removed when the phone was returned to the owner's pocket.

### BRIEF SUMMARY OF THE INVENTION

The invention relates to a lightweight cradle with flexible arms, which holds a cell phone in two planes. This method of mounting permits firm holding of the phone against vibration but easy release when it is time to remove it. The back of the cradle is coupled mechanically and electrically to a cigarette lighter prong. This coupling permits the telephone to be powered by the car's electrical system both during operation and when charging. Insertion into the lighter receptacle gives the cradle sufficient mechanical rigidity for this purpose due to built in springs in the prong. When the telephone is seated in the cradle, its antenna circuit is inductively coupled to external means by which increase in sensitivity and range is made possible.

### DESCRIPTION OF THE DRAWINGS

FIG. 1 is a perspective view of the invention showing the cradle and the phone to be held and the connection to a cigarette lighter plug.

FIG. 2 is a side view of the cradle showing the quick disconnect attachment for coupling the cradle to the cigarette lighter plug by means of an extruded button on the back of the cradle.

FIG. 3 is an isometric view of a clip, which will slip over a belt or similar article of clothing. The clip is formed with a slot in which an extruded button can be placed and rotatably locked said button being integrally attached to a cradle. When a cell phone is placed in the cradle, it can be carried by an individual and readily removed for use by unlocking the button.

### DETAILED DESCRIPTION OF THE INVENTION

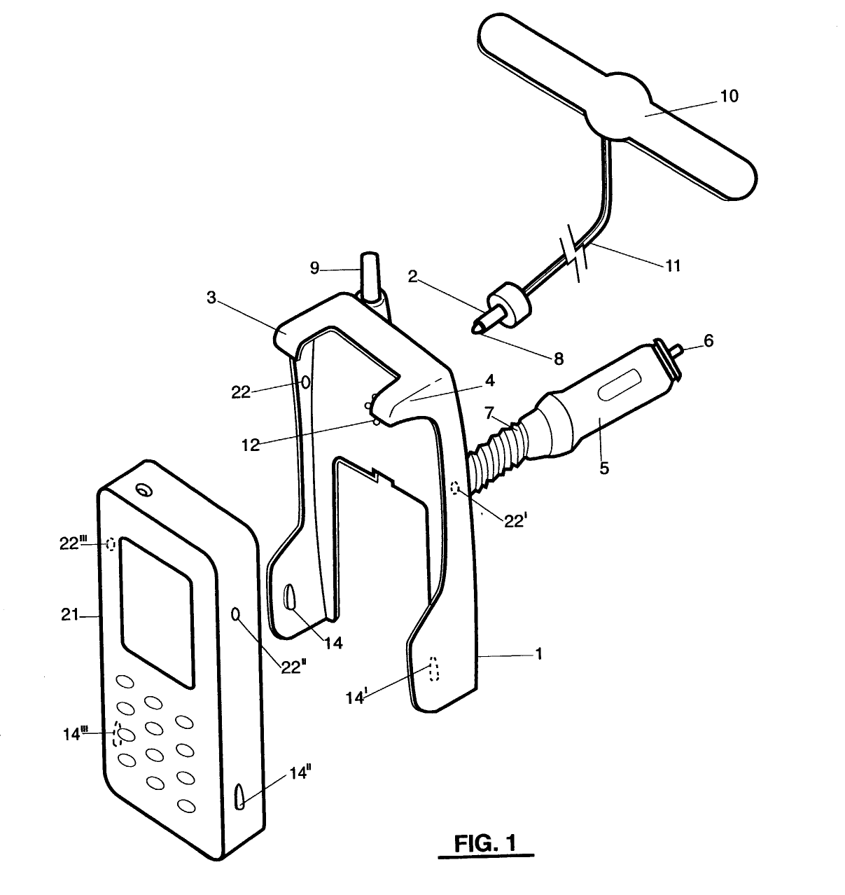

The invention will be described with reference to FIGS. 1, 2 and 3 which Illustrate a preferred embodiment. In FIG. 1 the cradle 1 which may be of molded plastic or sheet metal is configured to have the flexible fingers 3 and 4 and the protruding extensions 11 and 13. When the cell phone 9 having the indentations 10 and 10′ is pressed into the cradle, extensions 11 and 13 enter and lock into said indentations while flexible fingers 3 and 4 lock over edge 20 of the phone. This four sided locking will hold the cell phone firmly against accidental displacement but permit an easy release when desired.

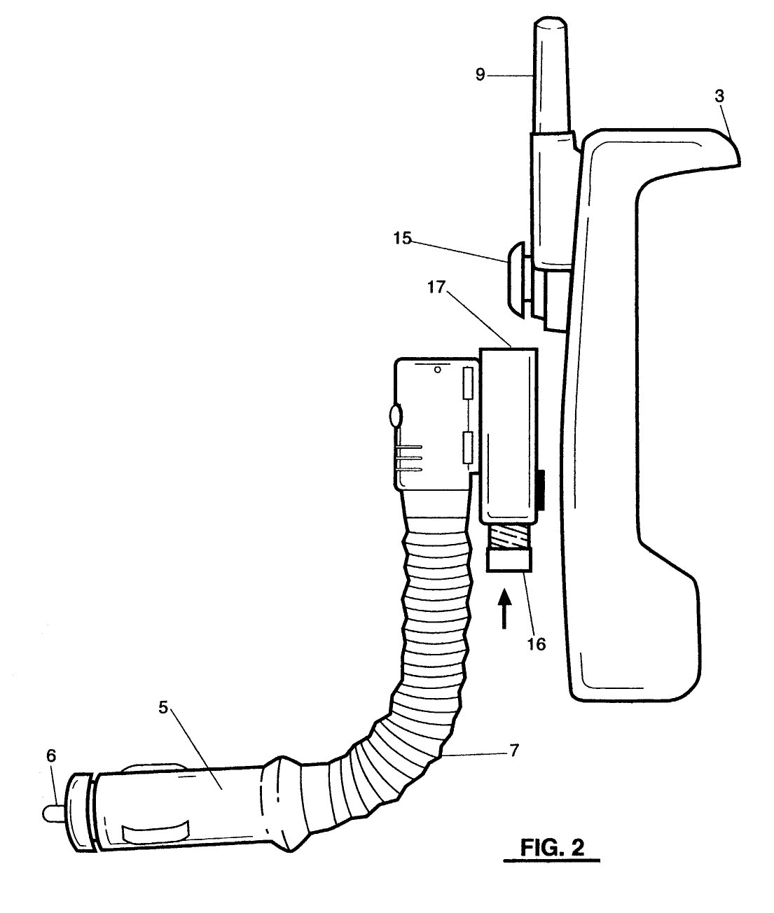

The back surface of the cradle is thick enough to house a second antenna 9 (FIG. 2) and an auxiliary microphone, which is sonically coupled through holes 12 (FIG. 1). This permits both sides of a conversation to be amplified and be heard on the car radio.

The back surface of the cradle also accommodates the electrical plug 2 attached by wire 11 to high gain antenna 10 which can be temporarily cemented on another surface (such as the car windshield) and thus increase the range of the telephone.

Buttons 21 and 21′ on the telephone make contact with electrodes 22 and 23′ on the cradle for charging.

The preferred method for attaching the cigarette lighter prong assembly 25 to the cradle can be seen in the side view of FIG. 2. The fixture 17, which is cemented to the prong assembly 25, contains a circular opening to accommodate button 15. Push button 16 activates a pin in the periphery of said opening. The pin is held in the groove between button 15 and the body of the cradle by spring 27. Pressure on button 16 releases the pin and allows the cradle to be separated from assembly 25.

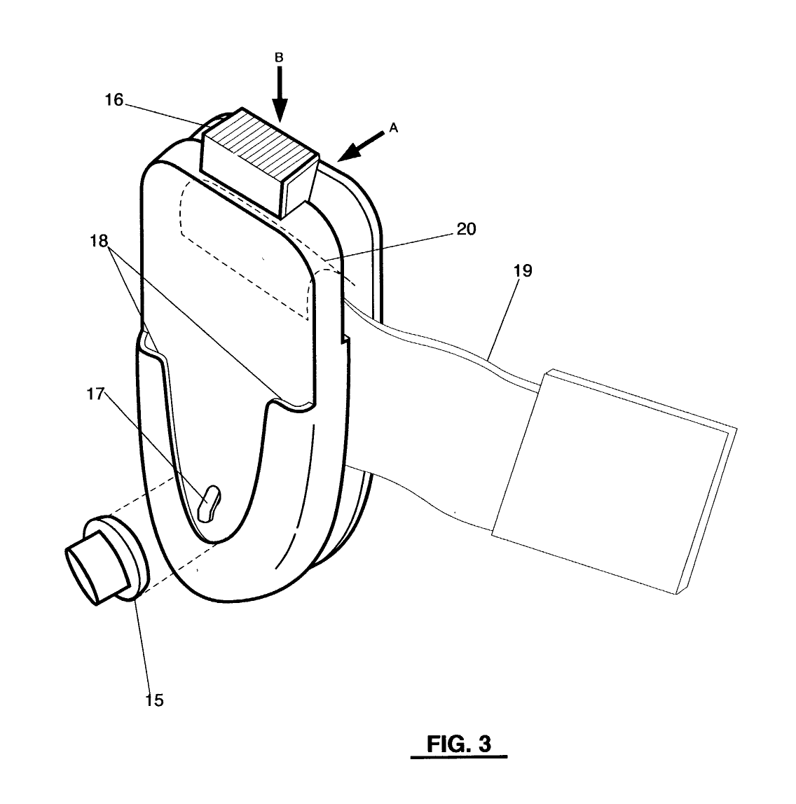

Another feature of the present invention is the provision for belt mounting of the cell phone and convenient carrying. This is shown in the perspective view of FIG. 3. The belt clip is made up of the base 29 and the moveable portion 30 separated by the spring 20. Pressure in direction A separates the moveable portion 30 from the base to accommodate the belt 19. The base 29 also incorporates the slots 18 into which the button 15 (which is part of the cradle) can slide. Pin 17 will fit into the space between 15 and the cradle and be held in place. The pin will be released when pressure is applied at B. The cell phone, which is being held in the cradle, will then be available for portable use or can be locked in place in the car assembly as explained previously.

The present invention provides adequate holding power for the use of a cell phone in an automobile in a “no hands” mode; ease of installation and removal; and convenient conversion to belt mounting. The cradle design requires a minimum of material for production and minimizes molding costs.

Although the described means for carrying out the invention is a preferred embodiment, the concept may be implemented by other designs without departing from the spirit of the invention.

1. A system for mounting a cell phone in an automobile to permit hands free use comprising:
a. Light weight cradle with means for ready acceptance of a cell phone body;
b. Means for coupling the phone to sensitive antennas when necessary;
c. Means for physically and electrically connecting the phone so as to permit recharging of the phone's battery and holding the phone so as to prevent dislodgement by the effects of road vibration;
d. Means for rapid and convenient disconnection and for return to manual transport and operation.

2. A system for mounting a cell phone in an automobile as described in claim 1 in which said light weight cradle is constructed of resilient material having extensions for retentive holding of a cell phone body and protrusions for fitting into slots in the phone body whereby the phone can easily be inserted into said cradle and be firmly held for a desired period.

3. A system for mounting a cell phone in an automobile as described in claim 1 in which said means for coupling the phone to an exterior, sensitive antenna is by inductance coils imbedded into said cradle which become adjacent to the cell phone when it is in said cradle.

4. A system for mounting a cell phone in an automobile as described in claim 1 in which said means for physically and electrically connecting the phone is a flexible tube and prong combination which permits said cradle to be plugged into a car's cigarette lighter socket.

5. A system for mounting a cell phone in an automobile as described in claim 1 in which additional coupling to an automobile's radio is by means of electrodes built into the phone and connecting to corresponding electrodes imbedded into said cradle

6. A system for mounting a cell phone in an automobile as described in claim 1 wherein said means for rapid and convenient disconnect include a belt clip with provision for attachment of said cradle holding a cell phone which permits the phone to be returned to non-vehicular and personal use.
